(19) United States
(12) Patent Application Publication
(10) Pub. No.: US 2025/0125841 A1
(43) Pub. Date: Apr. 17, 2025

(54) INTERPOLATION BASED UPLINK SUBBAND PRECODING WITH PHASE ROTATION

(71) Applicant: QUALCOMM Incorporated, San Diego, CA (US)

(72) Inventors: Yi HUANG, San Diego, CA (US); Yu ZHANG, San Diego, CA (US); Peter GAAL, San Diego, CA (US); Hyojin LEE, San Diego, CA (US)

(21) Appl. No.: 18/688,344

(22) PCT Filed: Nov. 1, 2021
(86) PCT No.: PCT/CN2021/127881

§ 371 Date: Feb. 29, 2024

(51) Int. Cl. H04B 7/0456; H04W 72/1268

(52) U.S. Cl. CPC H04B 7/0456; H04W 72/1268

(57) ABSTRACT

A UE receives DCI scheduling a PUSCH spanning multiple sub-bands, the DCI indicating a first precoder for a first resource grid of the PUSCH and a second precoder for a second resource grid of the PUSCH. The UE transmits the PUSCH with the first precoder at the first resource grid and with a third precoder at the second resource grid, the third precoder being based on a phase rotation of the second precoder. A base station transmits DCI scheduling a PUSCH spanning multiple sub-bands, the DCI indicating a first precoder for a first resource grid of the PUSCH and a second precoder for a second resource grid of the PUSCH. The base station receives the PUSCH with the first precoder at the first resource grid and with a third precoder at the second resource grid, the third precoder being based on a phase rotation of the second precoder.

### TECHNICAL FIELD

The present disclosure relates generally to communication systems, and more particularly, to wireless communication including precoding.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus receives downlink control information (DCI) scheduling a physical uplink shared channel (PUSCH) spanning multiple sub-bands, the DCI indicating a first precoder for a first resource grid of the PUSCH and a second precoder for a second resource grid of the PUSCH. The apparatus transmits the PUSCH with the first precoder at the first resource grid and with a third precoder at the second resource grid, the third precoder being based on a phase rotation of the second precoder.

In an aspect of the disclosure, a method, a computer-readable medium, and an apparatus are provided for wireless communication at a base station. The apparatus transmits DCI scheduling a PUSCH spanning multiple sub-bands, the DCI indicating a first precoder for a first resource grid of the PUSCH and a second precoder for a second resource grid of the PUSCH. The apparatus receives the PUSCH with the first precoder at the first resource grid and with a third precoder at the second resource grid, the third precoder being based on a phase rotation of the second precoder.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 illustrates an example of physical channel processing components 400 baseband signal generation including precoding, in accordance with various aspects of the present disclosure.

FIG. 5A illustrates an example of wideband precoding for a PUSCH.

FIG. 5B illustrates sub-band precoding for a PUSCH, in accordance with various aspects of the present disclosure.

FIG. 6 illustrates sub-band based precoding with linear interpolation, in accordance with various aspects of the present disclosure.

FIG. 7 illustrates phase rotation with interpolation based sub-band precoding, in accordance with various aspects of the present disclosure.

FIG. 8 illustrates an example of SRS transmission with frequency hopping.

FIG. 9 is an example communication flow diagram for wireless communication between a UE and a base station, in accordance with various aspects of the present disclosure.

FIGS. 10A and 10B are flowcharts of methods of wireless communication at a UE, in accordance with various aspects of the present disclosure.

FIG. 11 is a diagram illustrating an example of a hardware implementation for an example apparatus, in accordance with various aspects of the present disclosure.

FIGS. 12A and 12B are flowcharts of methods of wireless communication at a UE, in accordance with various aspects of the present disclosure.

FIG. 13 is a diagram illustrating an example of a hardware implementation for an example apparatus, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components, end-user devices, etc. of varying sizes, shapes, and constitution.

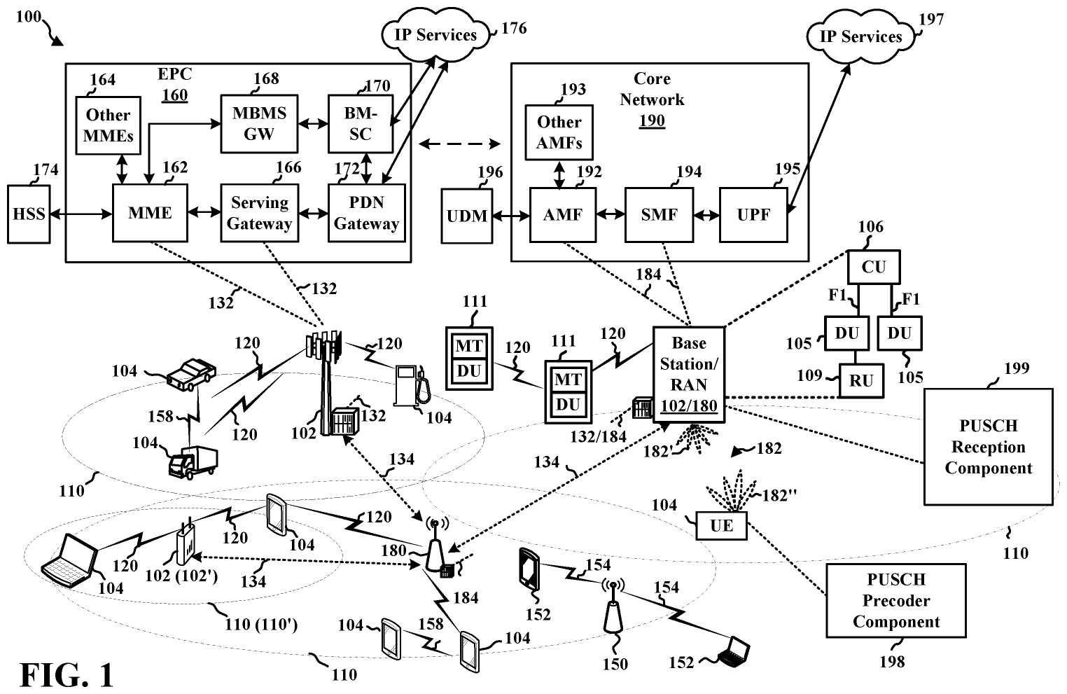

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184 (e.g., Xn interface), and the third backhaul links 134 may be wired or wireless.

In some aspects, a base station 102 or 180 may be referred as a RAN and may include aggregated or disaggregated components. As an example of a disaggregated RAN, a base station may include a central unit (CU) 106, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs 105 may be connected via an F1 interface. A DU 105 and an RU 109 may be connected via a fronthaul interface. A connection between the CU 106 and a DU 105 may be referred to as a midhaul, and a connection between a DU 105 and an RU 109 may be referred to as a fronthaul. The connection between the CU 106 and the core network may be referred to as the backhaul. The RAN may be based on a functional split between various components of the RAN, e.g., between the CU 106, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 106 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 106 and a DU 105. IAB nodes 111 may include a DU 105 and a mobile termination (MT). The DU 105 of an IAB node 111 may operate as a parent node, and the MT may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a PUSCH precoder component 198 that is configured to receive DCI scheduling a PUSCH spanning multiple sub-bands, the DCI indicating a first precoder for a first resource grid of the PUSCH and a second precoder for a second resource grid of the PUSCH. The PUSCH precoder component 198 may be configured to apply first precoder at the first frequency resource and with a third precoder at the second resource grid, the third precoder being based on a phase rotation of the second precoder. Each frequency grid may correspond to a tone, a set of tones, a resource element (RE), a set of REs, a resource block (RB), a set of RBs, etc. The UE 104 may transmit the PUSCH with the first precoder at the first resource grid and the third precoder at the second resource grid. The PUSCH precoder component 198 may be further configured to transmit the PUSCH at frequency resources between the first resource grid and the second resource grid with an interpolated precoder (e.g., a linearly interpolated precoder) based on the first precoder and the third precoder. A base station 102 or 180 may include a PUSCH reception component 199 that is configured to transmit DCI scheduling a PUSCH spanning multiple sub-bands, the DCI indicating a first precoder for a first resource grid and a second precoder for a second resource grid of the PUSCH and to receive the PUSCH with the first precoder at the first resource grid and with a third precoder at the second resource grid, the third precoder being based on a phase rotation of the second precoder. The PUSCH reception component 199 may be further configured to receive the PUSCH at resources between the first resource grid and the second resource grid with an interpolated precoder based on the first precoder and the third precoder, e.g., so that each frequency resource of the PUSCH is transmitted with an orthonormal precoder. Although the following description may be focused on 5G NR, the concepts described herein may be applicable to other similar areas, such as LTE, LTE-A, CDMA, GSM, and other wireless technologies.

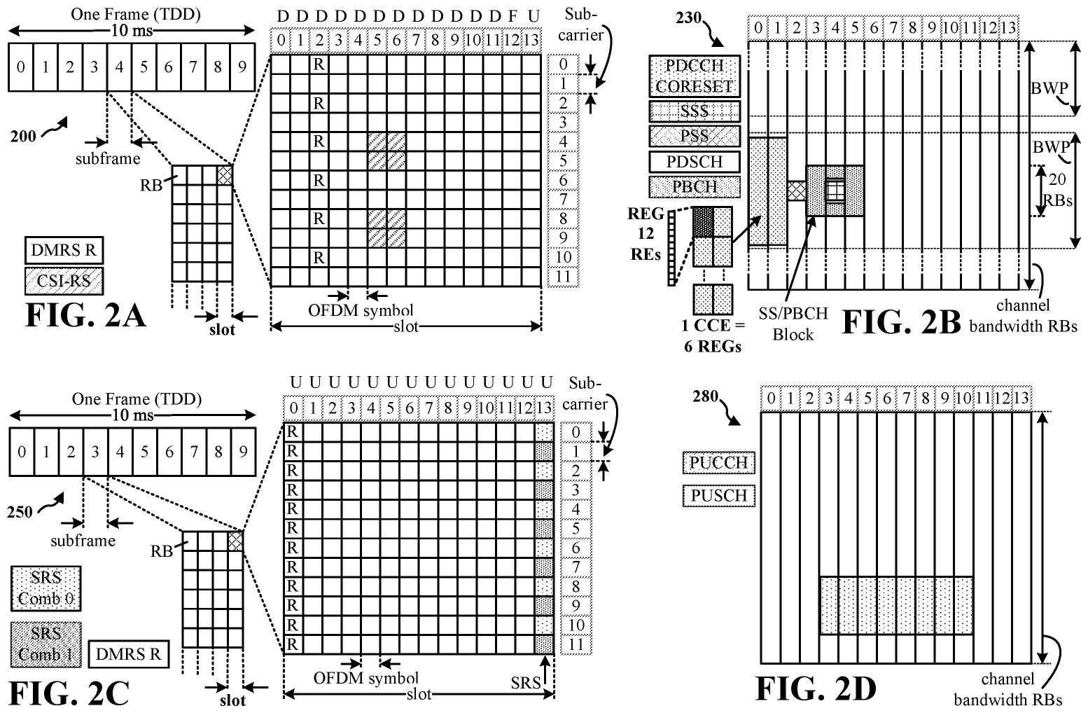

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

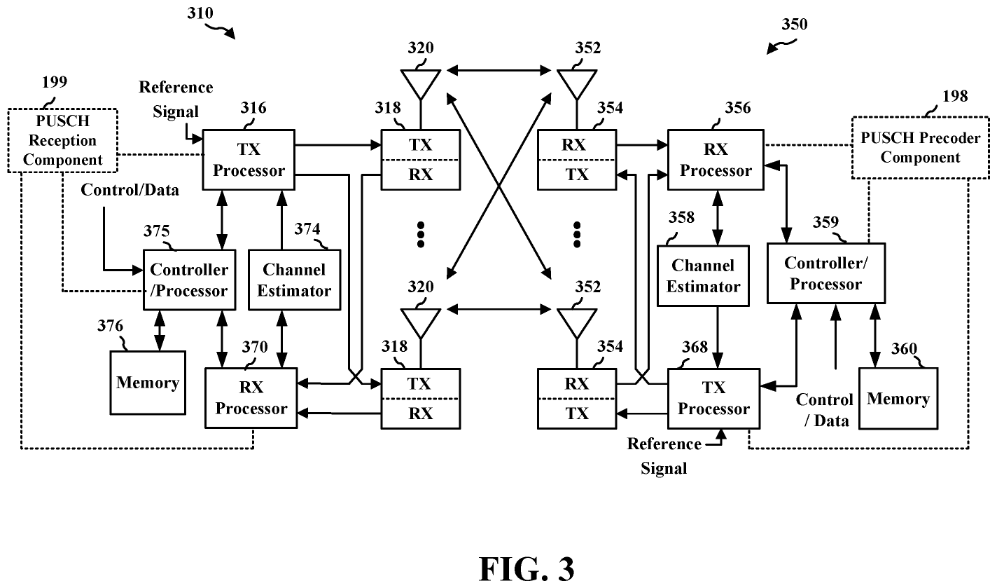

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the PUSCH precoder component 198 of FIG. 1.

At least one of the TX processor 316, the RX processor 370, and the controller/processor 375 may be configured to perform aspects in connection with the PUSCH reception component 199 of FIG. 1.

A transmitter of wireless communication may account for channel conditions between the transmitter and receiver when generating transmissions. In some aspects, the transmitter or receiver may be a base station. In some aspects, the transmitter or receiver may be a user equipment (UE). The transmitter may perform pre-transmission conditioning (e.g., precoding or beamforming for one or more transmissions). Pre-transmission conditioning can be based on one or more factors, such as channel measurements, e.g., and the transmitter may apply a precoder or beamformer based on channel measurements between the transmitter and receiver.

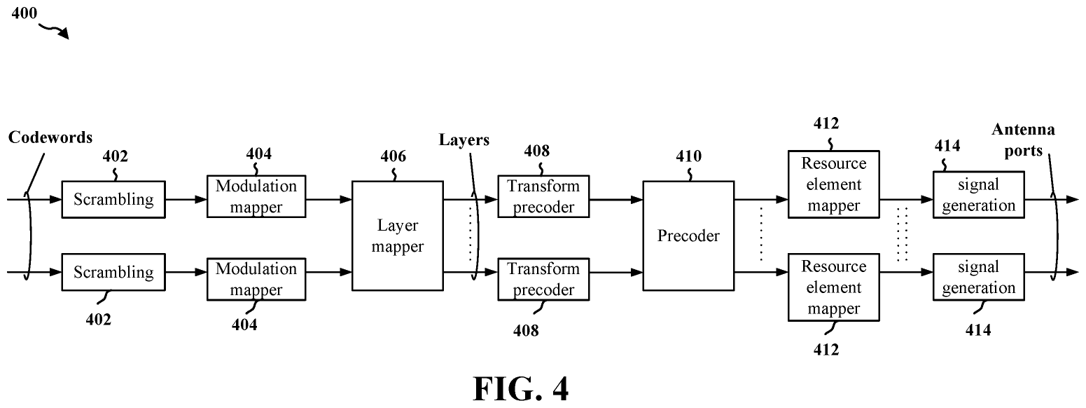

FIG. 4 illustrates an example of physical channel processing components 400 for baseband signal generation. The physical channel processing components may be comprised in the base station 310 or the UE 350, e.g., in Tx processor 316 or 368. The baseband signal generation may be used to generate physical channel such as PDSCH, PDCCH, PUSCH, PUCCH, PSSCH, PSCCH, etc. The baseband signal generation may include scrambling of codewords, as illustrated at 402. For example, a block of bits for a data transmission in a subframe may be scrambled prior to modulation. The scrambling sequence generator may be initialized at the start of each subframe, for example. The scrambled bits may be modulated by the modulation mapper(s) 404 to generate a block of complex-valued symbols. Example modulation schemes may include QPSK, 16 QAM, 64 QAM, etc. A layer mapper 406 may map the complex-valued modulation symbols onto one or more transmission layers. The layer mapping may be performed assuming a single antenna port. Transform precoder(s) 408 may apply transform precoding to generate complex-valued symbols. For example, a block of complex-valued symbols may be divided into sets, each set corresponding to one symbol. Then, transform precoding may be applied resulting in a block of complex valued symbols.

A precoder 410 may perform precoding of the complex-valued symbols. Precoding may be performed assuming a single antenna port or multiple antenna ports. The precoder 410 may receive a block of vectors from the transform precoder 408 and generate a block of vectors to be mapped onto resource elements. Then, the block of precoded complex valued symbols may be mapped in sequence to physical resource blocks, e.g., to resource elements, by the resource element mapper(s) 412. The precoded complex-valued symbols may be mapped in order to physical resource blocks that are assigned for transmission. Then, at 414, the time-domain signal may be generated for transmission at antenna port(s) based on the mapped resource elements.

As a part of signal generation, a transmitter may apply pre-transmission conditioning, such as precoding. Generally, precoding may be used to distribute information (e.g., data or control information) to be transmitted to one or more antenna ports. A precoder may use a matrix that maps information to one or more of the antenna ports of the transmitter. For example, the precoder may be associated with a MIMO precoding matrix that maps modulated data symbols from a single layer or multiple layers to multiple antennas. As such, the precoder may be different from an encoder for encoding an information bit stream. The precoding/precoder may be implemented as hardware, software, or both, based on an implementation of the transmitter. Table 1 illustrates an example set of precoding matrices for a single layer transmission using two antenna ports. Table 2 illustrates an example set of precoding matrices for a single layer transmission using four antenna ports. Tables 1 and 2 are merely examples to illustrate the concept. The concepts may be applied with different precoding matrices than the examples in Table 1 and 2.

TABLE 1
Precoding matrix W for single layer transmission using two antenna ports

| | | | | | | | |
|---|---|---|---|---|---|---|---|
| $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 2
Precoding matrix W for single layer transmission using four antenna ports

| | | | | | | | |
|---|---|---|---|---|---|---|---|
| $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

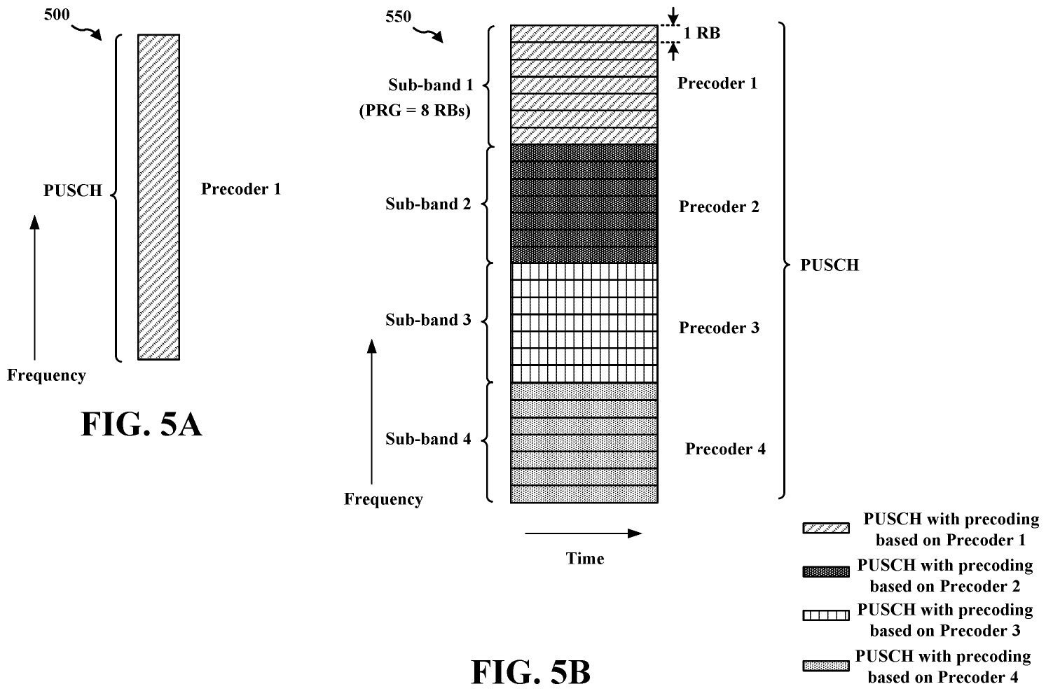

FIG. 5A illustrates an example 500 of a PUSCH with an uplink MIMO precoder that is based on a wideband precoding. As an example, a base station (e.g., 102, 180, or 310) may indicate to a UE (e.g., 104 or 350) to use a particular transmission precoding matrix indicator (TPMI) to transmit a PUSCH. The precoder may be a codebook based precoding matrix or a non-codebook based precoding matrix. As an example, a DCI scheduling resources for a PUSCH transmission may include information that indicates a TPMI (e.g., indicating a single precoder) for the UE to use for the whole bandwidth of the scheduled PUSCH transmission. In the example in FIG. 5A, the UE may apply the precoding matrix indicated by the DCI across the frequency resources of the PUSCH, e.g., to all of the RBs of the PUSCH. FIG. 5A illustrates a single precoder applied to the PUSCH transmission. The precoder matrix may be referred to as a “precoder.” The application of the precoding matrix to the complex-valued symbols of the PUSCH may be referred to as “precoding” or “applying the precoder.”

FIG. 5B illustrates an example 550 of a PUSCH with sub-band dependent decoding in which different precoders are applied to different sub-band of the PUSCH transmission. The sub-band dependent precoding provides frequency selectivity of a channel across the different sub-bands. The use of the different precoders for different sub-bands provides more flexibility for the precoding, and the different precoders may address the different levels of interference. The precoder may be channel dependent, and the channel may be sub-band dependent so that the precoder may also be sub-band dependent. may enable variation for different interference levels that may vary across different sub-bands. Additionally, or alternatively, the multiple user (MU) pattern may vary in different sub-bands. For example, multiple users may be scheduled in one sub-band, and few users or a single user may be scheduled in another sub-band. The ability to have a different precoder in different sub-band of the PUSCH enables the use of a precoder that is more aligned with the conditions of a particular sub-band for the PUSCH. FIG. 5B illustrates an example in which the sub-bands may span 8 RBs. As an example, the DCI scheduling the PUSCH may instruct the UE to transmit the PUSCH on 32 RBS and to partition the RBs into four subbands. The base station may also indicate to the UE to use different precoders for the different sub-bands. For example, the DCI scheduling the PUSCH may indicate for the UE to use precoder 1 for sub-band 1, precoder 2 for sub-band 2, precoder 3 for sub-band 3, and precoder 4 for sub-band 4. The granularity of the sub-bands may be different in other examples. For example, a granularity of the sub-bands having different precoders may be a set of multiple RBs. In other aspects, the sub-bands having different precoders may each be a single RB. In other aspects, the sub-bands having different precoders may be a set of tones (e.g., a set of subcarriers). In other aspects, the sub-bands having different precoders may be a single tone (e.g., a single subcarrier). For example, the granularity of the sub-bands may be one or more RBs or one or more tones (e.g., subcarriers). The network may define, or indicate, the granularity for the sub-bands.

The base station may signal the UL TPMIs for sub-band precoding to the UE in the DCI scheduling the PUSCH transmission. The base station may signal one TPMI for each sub-band needs one TPMI. The DCI overhead to signal the TPMIs may be very large depending on the granularity of the sub-bands. As an example, if a sub-band corresponds to a single tone, the DCI may signal a TPMI for each tone of the PUSCH transmission. The DCI size becomes variable, with the size of the DCI depending on the total number of RBs in the scheduled PUSCH and/or the granularity of the sub-bands. In order to receive the DCI, the UE attempts to decode the DCI based on multiple hypotheses for the DCI size. The potential hypotheses that are to be attempted by the UE may become large when accounting for sub-band level precoding (e.g., the DCI including a TPMI for each sub-band of the PUSCH being scheduled).

As an example, if the subband granularity is X RBs, for a PUSCH assignment spanning Y RBs, the total number of TPMIs signaled in the DCI scheduling the PUSCH is based on Y/X, which may be written as:

$$Total number of TMP Is = ceiling ( Y / X ) .$$

If the DCI includes B bits to indicate each TPMI, the total number of bits to indicate all of the TPMIs for the PUSCH is a function of the number of RBs for the scheduled PUSCH, and may be written as:

Total number of bits in DCI to indicate the TPMIs=B*ceiling(Y/X)

The UE does not know the number of RBs of the PUSCH until it decodes the DCI, and therefore does not know the number of bits to indicate the TPMIs. Therefore, the UE attempts to decode the DCI based on multiple size hypotheses for the DCI.

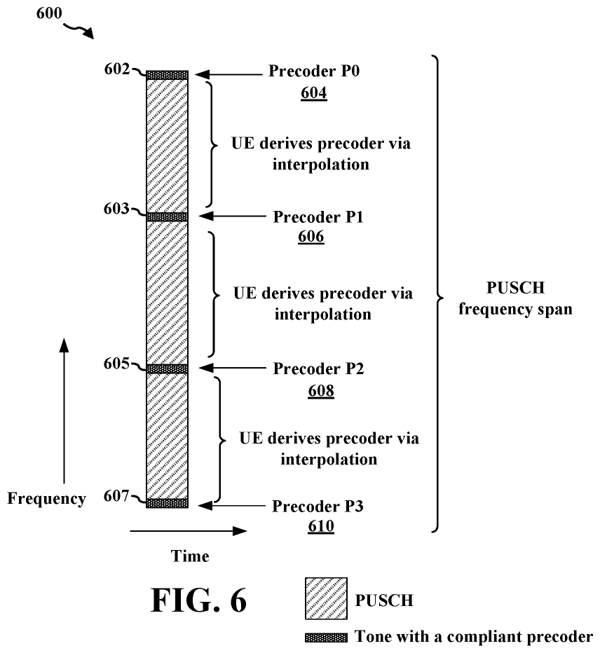

FIG. 6 illustrates an example 600 showing interpolation based sub-band precoding in which the base station may indicate a fixed number of precoders when scheduling PUSCH (e.g., P0, P1, P2, and P3 in the example in FIG. 6). The fixed number may help to reduce the processing at the UE to attempt to decode the DCI because there may be less variability in the DCI size. Instead of indicating a TPMI for each sub-band, the network may indicate a fixed number of precoders for certain resource grids, e.g., independent of the PUSCH assignment. In FIG. 6, the example shows a resource grid example of a tone. However, the concepts presented herein may be applied for other sizes of resource grids, e.g., one or more REs, or one or more RBs. The base station may indicate L tones, and the base station may indicate the precoder to be used at the L tones. The value of L may be configured, e.g., in RRC signaling. For example, the value of L may be invariant. In the example in FIG. 6, the base station may RRC configure the UE with an indication that L=4, so that the UE knows that a scheduled PUSCH will have a particular precoder at 4 tones of the PUSCH. The base station may then indicate the four precoders for the 4 tones to the UE. As an example, the base station may indicate the four precoders to the UE in the DCI scheduling the PUSCH. As the UE will know that the base station will send 4 TPMIs in the DCI, the UE may reduce the number of hypotheses to be attempted to decode the DCI. The example of L=4 is merely one example, and may L may be any integer number of 2 or more.

As illustrated in the example in FIG. 6, the UE may apply the first precoder 604 at a tone 602 at a frequency edge of the PUSCH, and the other tones may be equally spaced within the PUSCH transmission. The UE may apply a last precoder 610 at a tone 607 that is at the opposite frequency edge of the PUSCH from the tone 602. FIG. 6 illustrates the tone 603 (e.g., to which the precoder 606 is applied) and the tone 605 (e.g., to which the precoder 608 is applied) being equally spaced within the PUSCH.

For the tones between the four tones with the indicated precoders, the UE may perform interpolation to derive precoders. Each group of tones between the tones with the indicated precoders may be referred to as a sector. In the example in FIG. 6, a precoder may be linearly interpolated for each tone of the PUSCH.

Although the example for FIG. 6 describes an example with L tones, in order to illustrate the concept, the concept may also be applied to other granularities for L. As an example, L may be for an RB, and the base station may indicate L precoders to be applied to L RBs. The UE may interpolate the precoder for each RB between the RBs with the indicated precoders. In another example, the granularity of L may be a set of RBs.

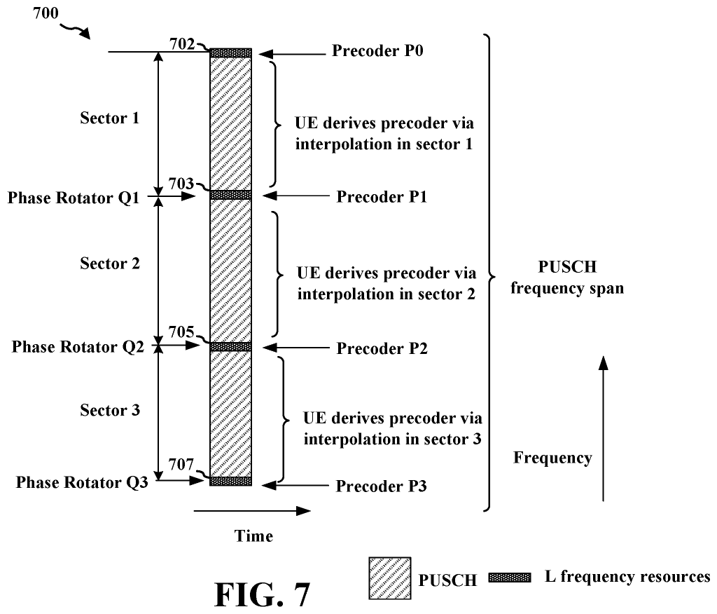

In addition to the linear interpolation, the UE may also apply a phase rotation to the L precoders with linear interpolation between the phase rotated liner decoders. FIG. 7 illustrates an example 700 of a PUSCH having for which the base station indicates L precoders for a set of L frequency resources (e.g., tones, set of tones, RBs, set of RBs, etc.), and the UE applies a linearly interpolated precoder to the frequency resources between the set of L frequency resources, e.g., as described in connection with FIG. 6. In addition to the linear interpolation of FIG. 6, the UE also applies phase rotation.

As an example, the base station may indicates L precoders Pᵢ for the L tones, with i=1 to L. The base station may select the precoder Pᵢ based on Vᵢ matrix in a singular value decomposition (SVD) operation at the base station, e.g., based on Hᵢ=UᵢDᵢVᵢ. The UE may perform a piecewise linear interpolation for an intermediate i-th tone in a sector j. As an example, the UE may perform a linear interpolation based on:

$${F}_{i , j} = {a}_{i} {P}_{j - 1} + {b}_{i} {Q}_{j} {P}_{j}$$

In this example, Qⱼ is a sector dependent phase rotation matrix to optimize the interpolation performance. The parameters aᵢ and bᵢ are two scaler weighting factors. With linear interpolation, aᵢ and bᵢ may depend on relative tone locations/indexes in each sector, and may be common for each of the sectors. With more complicated interpolation, aᵢ and bᵢ may be different for different sectors.

The UE may then orthogonalize or normalize the interpolated matrix to obtain an orthonormal precoder for i-th tone in a sector j (P_{i,j}) As an example,

$${P}_{i , j} = {{F}_{i , j} ( {F}_{i , j}^{H} {F}_{i , j} )}^{- 1 / 2}$$

FIG. 7 illustrates that a first frequency resource 702 of the set of L frequency resources or resource grids (e.g., tone, set of tones, RE, set of REs, RB, set of RBs, etc.) may be precoded with a first precoder (P0) indicated by the base station and without a phase rotation, a second 703 of the L frequency resources/resource grids may be precoded with the second precoder (P1) indicated by the base station after application of a phase rotator Q1. A third 705 of the L frequency resources/resource grids may be precoded with the third precoder (P3) indicated by the base station after application of a second phase rotator Q2. A fourth 707 of the L frequency resources/resource grids may be precoded with the fourth precoder (P4) indicated by the base station after application of a second phase rotator Q3.

The frequency resources/resource grids between 702 and 703 may be referred to as a first sector, and the UE may derive the precoder via interpolation based on:
aᵢP₀+bᵢQ₁ P₁ for i-th tone in 1^{st} sector

The frequency resources/resource grids between 703 and 705 may be referred to as a second sector, and the UE may derive the precoder via interpolation based on:
aᵢP₁+bᵢQ₂ P₂ for i-th tone in 2^{nd} sector

The frequency resources/resource grids between 705 and 707 may be referred to as a third sector, and the UE may derive the precoder via interpolation based on:
aᵢP₂+bᵢQ₃ P₃ for i-th tone in 3^{rd} sector

Based on a MIMO theory, the solution of Vᵢ may not be unique, and QᵢVᵢ may also be the solution of the SVD, as long as Qᵢ is orthonormal. In order to optimize the interpolation performance, the UE have the freedom to adjust the Pᵢ matrix via multiplying it with an orthonormal matrix Qᵢ, which can be viewed as a phase rotation of the L precoders Pᵢ signaled by base station.

The phase rotation matrix may be determined per sector for the sector based interpolation. The per sector phase rotation breaks the phase continuity across the wideband, e.g., across the overall frequency span of the PUSCH, and may lead to an optimized interpolation performance. In some aspects, the per sector phase rotation may not allow for a time domain channel estimation or a wideband frequency domain channel estimation, due to phase discontinuity. A PUSCH with precoders having phase discontinuity may have a larger adjacent channel leakage ratio (ACLR), a larger out of band emission (OBE), or inter-modulation. In some aspects, a base station may determine whether to prioritize or focus on one type of performance over another type of performance and may indicate for the UE to apply precoders with phase rotation or not to apply precoders with phase rotation. For example, the base may determine between optimizing, or improving, interpolation performance through the use of phase rotation or allowing for receiver channel estimation performance and/or minimizing ACLR/OBE/inter-modulation through PUSCH precoding without phase rotation. In some aspects, the base station may provide control signaling to enable or disable the UE from performing phase rotation with interpolation based sub-band precoding.

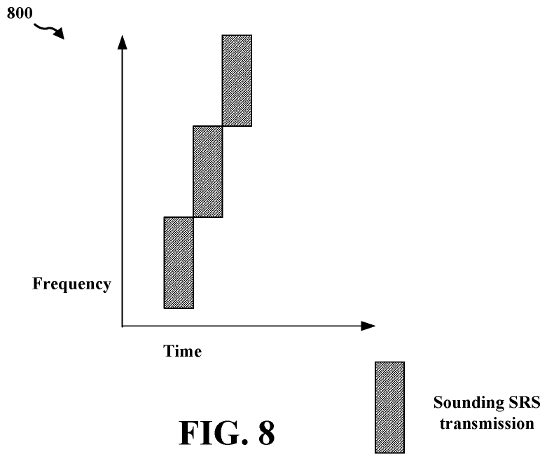

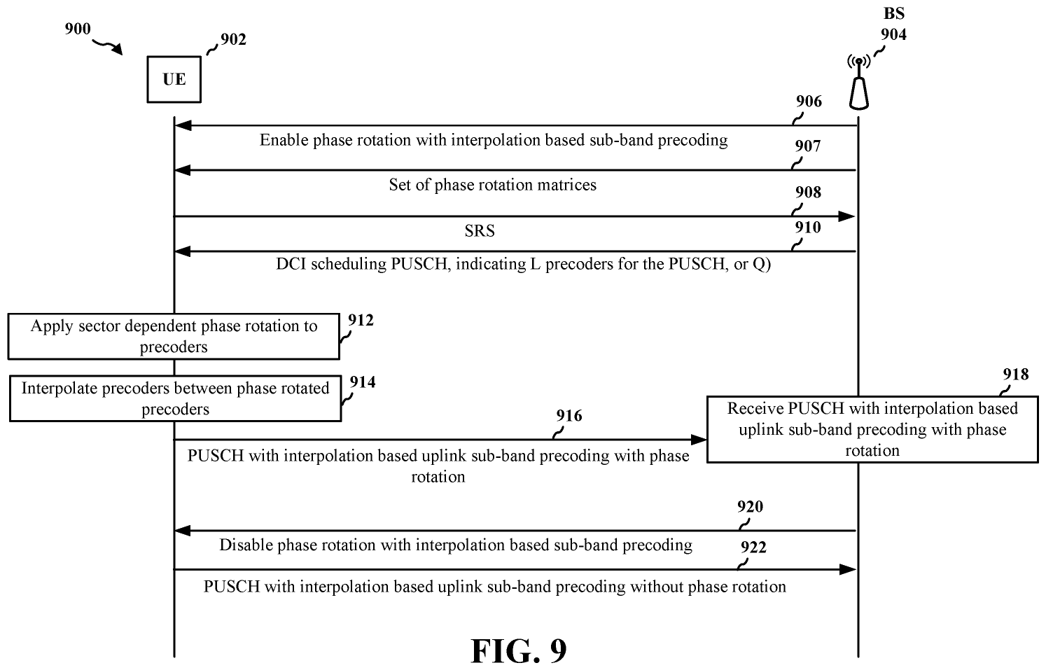

FIG. 9 illustrates an example communication flow 900 between a UE 902 and a base station 904 that includes the transmission of PUSCH with phase rotation with interpolation based sub-band precoding. In some aspects, the base station 904 may provide control signaling 906 to enable or disable the UE from performing phase rotation with interpolation based sub-band precoding. As an example, the base station 904 may send one or more bit of information, at 906, to the UE 902 to enable or disable the UE from performing the phase rotation with interpolation based sub-band precoding. The signaling may include one or more bit in DCI. The signaling may include one or more bit in an RRC message. The signaling may include one or more bit in a MAC-CE. In some aspects, the indication may be implicitly provided to the UE. In some aspects, if the UE is configured, or scheduled, to perform SRS sounding with sub-band based frequency hopping, the scheduling/configuration for the SRS sounding may indicate to the UE not to perform phase rotation with interpolation based sub-band precoding. Thus, if the UE transmits SRS 908 with frequency hopping, the UE may skip phase rotation of the precoders for the PUSCH. With SRS frequency hopping, the uplink channel observed by the base station, which is used to determine the L precoders, is without phase continuity. The base station may then expect the interpolated subband precoders applied by the UE for the PUSCH to maintain phase continuity cross different sectors, e.g., as in FIG. 6 as opposed to FIG. 7. In some aspects, the UE 902 may autonomously apply phase rotation per sector, e.g., as a default, without an indication by the base station 904 (e.g., without 906) to enable the phase rotation per section. In such aspects, the UE 902 may apply the phase rotation unless the base station 904 indicates not to apply the phase rotation. FIG. 8 illustrates an example time and frequency diagram 800 in which the UE may transmit SRS by hopping to different frequencies over time.

In some aspects, the base station 904 may provide a two level enablement/disablement of the phase rotation with interpolation based sub-band precoding. The base station 904 may indicate a first set of one or more bits that indicates that interpolation based sub-band precoding is enabled. The base station 904 may indicate a second set of one or more bits indicating that phase rotation is enabled for the interpolation based sub-band precoding. The two indications may be included in a single message, e.g., 906, or may be included in separate messages.

Additionally, or alternatively, the base station 904 may indicate the potential phase rotation matrices, i.e., the set of Qᵢ, that the UE may use to do phase rotation with the interpolation, e.g., at 907.

As an example, the base station may signal, at 907, a phase rotation matrix codebook, which includes a set of orthonormal matrices Qᵢ that the UE may use to do phase rotation. In some aspects, the base station 904 may signal the phase rotation matrix codebook via RRC signaling or in a MAC-CE.

A UE may choose Qᵢ from the phase rotation matrix codebook in various ways. As an example, the UE may pick any Qᵢ in the signaled codebook without any restriction.

In other aspects, the base station may indicate to the UE in DCI, e.g., 910, the Qᵢ to use to pair with each Pᵢ. The base station may signal two set of indices, L indices for precoders Pᵢ and L or L−1 indices for the phase rotation matrices Qᵢ, for example.

The UE may transmit SRS 908, which the base station 904 may measure to determine characteristics about the channel, e.g., including for different sub-bands. At 910, the base station transmits DCI scheduling the UE 902 for a PUSCH transmission and indicating a set of L precoders, e.g., as described in connection with FIGS. 6 and 7. At 912, the UE may apply a sector dependent phase rotation to the indicated precoders, e.g., as described in connection with FIG. 7. Then, at 914, the UE may interpolate precoders (e.g. linearly interpolate) for the frequency resources in each of the sectors between the phase rotated precoders. The UE may apply the phase rotation and linearly interpolation based on the enablement by the base station, e.g., at 906, in some aspects. At 916, the UE transmits the PUSCH with the phase rotation and interpolation sub-band based precoding. The base station 904 receives the PUSCH, at 918, based on the phase rotation and interpolation sub-band based precoding applied by the UE 902.

In some aspects, the base station 904 may later disable phase rotation and/or interpolation based sub-band precoding, at 920. The indication, at 920, may be in RRC signaling, DCI, or a MAC-CE. In response, at 922, the UE 902 may transmit the PUSCH without the phase rotation with linearly interpolation sub-band based precoding.

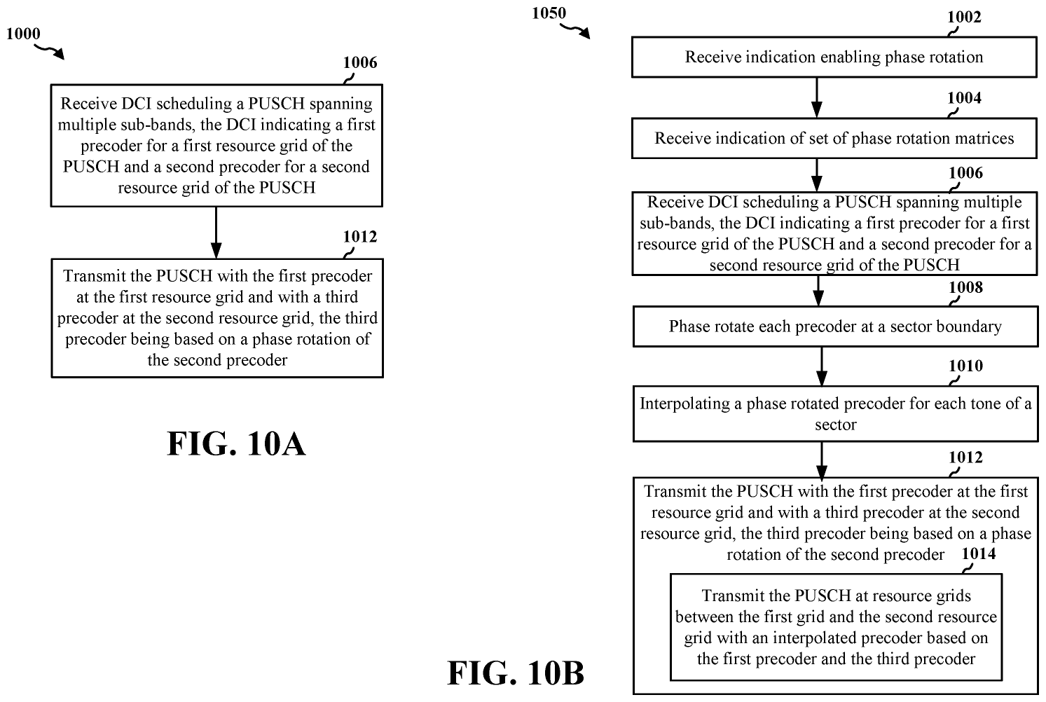

FIG. 10A is a flowchart 1000 of a method of wireless communication. The method may be performed by a UE (e.g., the UE 104, 350, 902; the apparatus 1102). The method may provide for improved interpolation of a PUSCH based on phase rotation with linear interpolation sub-band based precoding.

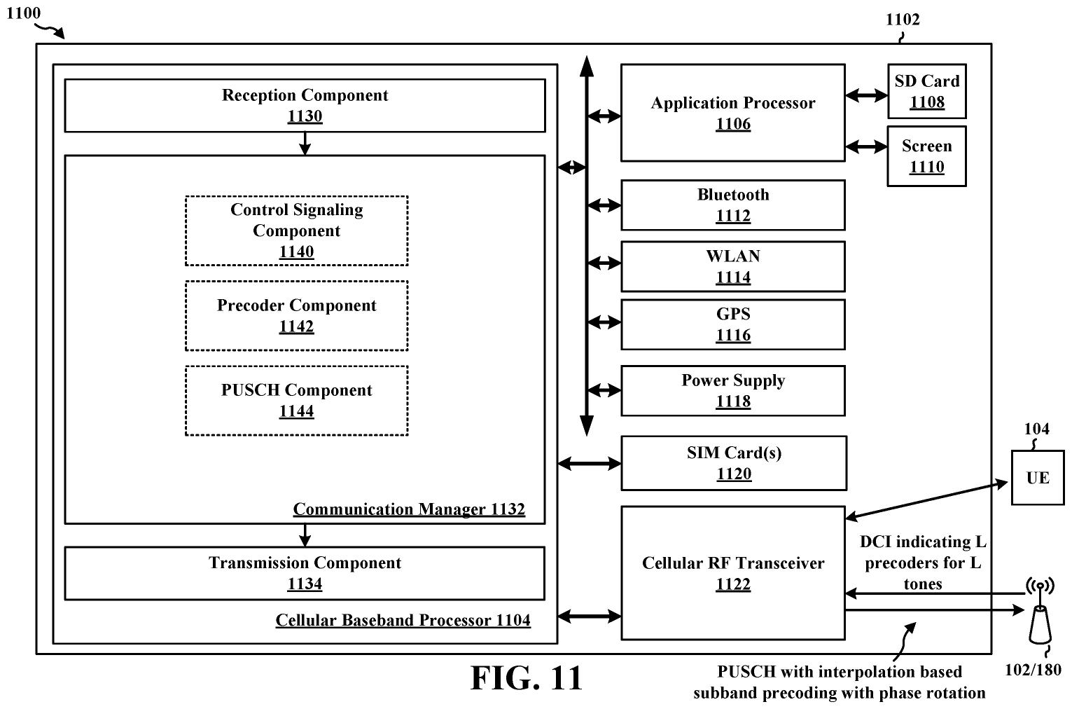

At 1006, the UE receives DCI scheduling a PUSCH spanning multiple sub-bands, the DCI indicating a first precoder for a first resource grid of the PUSCH and a second precoder for a second resource grid of the PUSCH. The DCI may indicate a set of precoders for a set of resource grids of the PUSCH, each of the set of resource grids being associated with a frequency sector. The reception may be performed, e.g., by the control signaling component 1140 of the apparatus 1102 in FIG. 11. FIG. 9 illustrates an example of a DCI received by the UE, at 910. Each resource grid may correspond to an RE, a set of REs, an RB, or a set of RBs.

At 1012, the UE transmits the PUSCH with the first precoder at the first resource grid and with a third precoder at the second resource grid, the third precoder being based on a phase rotation of the second precoder. The phase rotation may include multiplication of the second precoder by an orthonormal matrix. In some aspects, the orthonormal matrix may be an identity matrix. The transmission may be performed, e.g., by the PUSCH component 1144 of the apparatus 1102 in FIG. 11. FIG. 9 illustrates an example of the UE 902 transmitting a PUSCH 916. The PUSCH may include any of the aspects described in connection with FIG. 7.

FIG. 10B illustrates a flowchart 1050 of a method of wireless communication that may include the reception of the DCI as in 1006 and the transmission of the PUSCH, as in 1006 of FIG. 10A.

As illustrated at 1008, the UE may phase rotate each precoder at a sector boundary. The frequency sector may span a set of one or more RBs. The frequency sector may span a number of one or more REs. The phase rotation may be performed, e.g., by the precoder component 1142 of the apparatus 1102 in FIG. 11. FIG. 7 illustrates example aspects of applying phase rotation at a set of L frequency resources for a PUSCH. FIG. 9 illustrates that the UE 902 may apply a sector dependent phase rotation to one or more of the precoders indicated by the base station in the DCI, at 912. In some aspects, the DCI, received at 1006 may indicate a set of precoders for a set of resource grids of the PUSCH, each resource grid of the set of resource grids being associated with a frequency sector.

As illustrated at 1010, the UE may interpolate between two precoders to obtain a corresponding precoder for resource grids between two closest resource grids of the set of resource grids for which the set of precoders are indicated. The interpolation may be linear interpolation, in some aspects. The interpolation may be performed, e.g., by the precoder component 1142 of the apparatus 1102 in FIG. 11. Aspects of interpolation are described in connection with FIGS. 6 and 7. FIG. 9 illustrates an example of a UE 902 performing linear interpolation for each frequency resource of a sector, at 914.

As illustrated at 1014, the UE may transmit the PUSCH at resource grids between the first resource grid and the second resource grid with an interpolated precoder based on the first precoder and the third precoder. The interpolated precoder may be based on linear interpolation. Each resource grid of the PUSCH may be precoded with a precoder that is orthogonalized and normalized based on the interpolated precoder. The transmission may be performed, e.g., by the PUSCH component 1144 of the apparatus 1102 in FIG. 11.

In some aspects, as illustrated at 1002, the UE may receive an indication from the base station enabling sub-band precoding with the phase rotation. FIG. 9 illustrates an example of a UE 902 receiving an indication 906 from the base station. The enablement/disablement may enable more variation or adaptation to the current conditions of a channel. In some aspects, at 1004, the UE may receive an indication from the base station of a set of at least one phase rotation matrix, the phase rotation being based, at least in part, on the indication. The reception of the indications may be performed, e.g., by the control signaling component 1140 of the apparatus 1102. FIG. 9 illustrates an example of a UE 902 receiving an indication 907 from the base station 904.

FIG. 11 is a diagram 1100 illustrating an example of a hardware implementation for an apparatus 1102. The apparatus 1102 may be a UE, a component of a UE, or may implement UE functionality. In some aspects, the apparatus1102 may include a cellular baseband processor 1104 (also referred to as a modem) coupled to a cellular RF transceiver 1122. In some aspects, the apparatus 1102 may further include one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, or a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the additional modules of the apparatus 1102.

The communication manager 1132 includes a control signaling component 1140 that is configured to receive DCI scheduling a PUSCH spanning multiple sub-bands, the DCI indicating a first precoder for a first resource grid of the PUSCH and a second precoder for a second resource grid of the PUSCH, e.g., as described in connection with 1006 in FIG. 10A or 10B. The control signaling component 1140 may be further configured to receive an indication that phase rotation is enabled, e.g., as described in connection with 1202 and/or an indication of a set of one or more phase rotation matrices, e.g., as described in connection with 1004 in FIG. 10B. The communication manager 1132 further includes a precoder component 1142 that receives input in the form of the precoder information from the control signaling component 1140 and is configured to apply the first precoder at the first frequency resource of the PUSCH and with a third precoder at the second frequency resource of the PUSCH, the third precoder being based on a phase rotation of the second precoder. The precoder component 1142 may be further configured to phase rotate each precoder at a sector boundary, e.g., as described in connection with 1008 in FIG. 10B. The precoder component 1142 may be further configured to interpolate between two precoders to obtain a corresponding precoder for resource grids between two closest resource grids of the set of resource grids for which the set of precoders are indicated, e.g., as described in connection with 1010 in FIG. 10B. The communication manager 1132 further includes a PUSCH component 1144 that is configured to transmit the PUSCH with the first precoder at the first resource grid and with a third precoder at the second resource grid, the third precoder being based on a phase rotation of the second precoder, e.g., as described in connection with 1012 in FIG. 10A or 10B. The PUSCH component 1144 may be further configured to transmit the PUSCH at resource grids between the first resource grid and the second resource grid with an interpolated precoder based on the first precoder and the third precoder, e.g., as described in connection with 1014 in FIG. 10B.

The apparatus may include additional components that perform each of the blocks of the algorithm in the flowcharts of FIGS. 10A and 10B and/or the aspects performed by the UE in the communication flow in FIG. 9. As such, each block in the flowcharts of FIGS. 10A and 10B and/or the aspects performed by the UE in the communication flow in FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1102 may include a variety of components configured for various functions. In one configuration, the apparatus 1102, and in particular the cellular baseband processor 1104, includes means for receiving DCI scheduling a PUSCH spanning multiple sub-bands, the DCI indicating a first precoder for a first resource grid of the PUSCH and a second precoder for a second resource grid of the PUSCH; and means for transmitting the PUSCH with the first precoder at the first resource grid and with a third precoder at the second resource grid, the third precoder being based on a phase rotation of the second precoder. The apparatus 1102 may further include means for phase rotating each precoder at a sector boundary. The apparatus 1102 may further include means for interpolating between two precoders to obtain a corresponding precoder for resource grids between two closest resource grids of the set of resource grids for which the set of precoders are indicated. The apparatus 1102 may further include means for transmitting the PUSCH at resource grids between the first resource grid and the second resource grid with an interpolated precoder based on the first precoder and the third precoder. The apparatus 1102 may further include means for receiving an indication from the base station enabling sub-band precoding with the phase rotation. The apparatus 1102 may further include means for receiving an indication from the base station of a set of at least one phase rotation matrix, the phase rotation being based, at least in part, on the indication. The means may be one or more of the components of the apparatus 1102 configured to perform the functions recited by the means. As described supra, the apparatus 1102 may include the TX Processor 368, the RX Processor 356, and the controller/processor 359. As such, in one configuration, the means may be the TX Processor 368, the RX Processor 356, and the controller/processor 359 configured to perform the functions recited by the means.

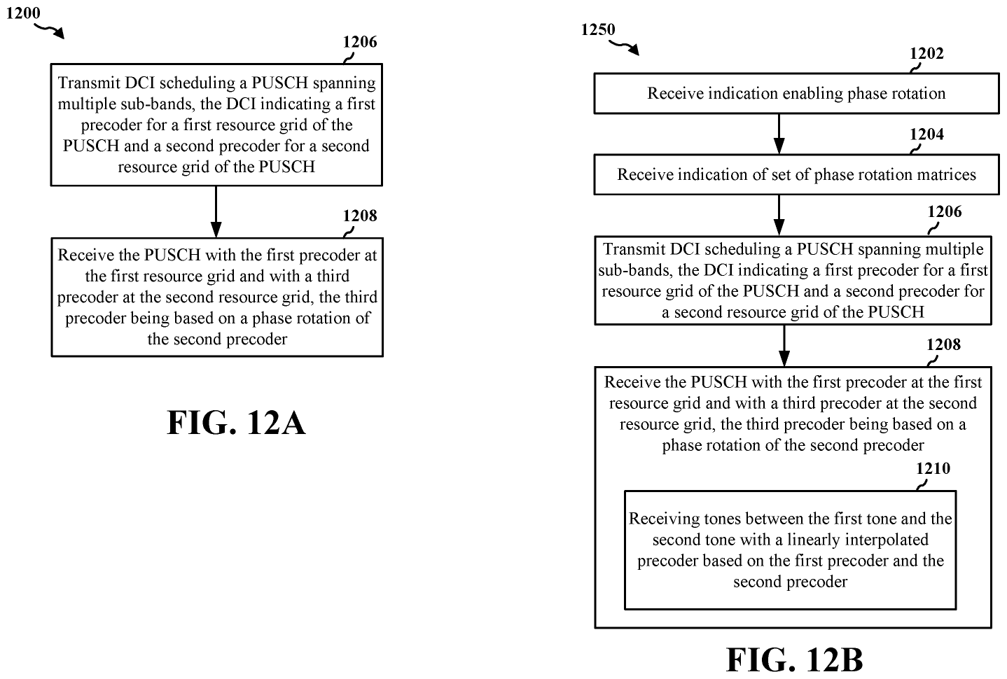

FIG. 12A is a flowchart 1200 of a method of wireless communication. The method may be performed by a base station (e.g., the base station 102, 180, 310, 904; the apparatus 1302). The method may provide for improved interpolation of a PUSCH based on phase rotation with linear interpolation sub-band based precoding.

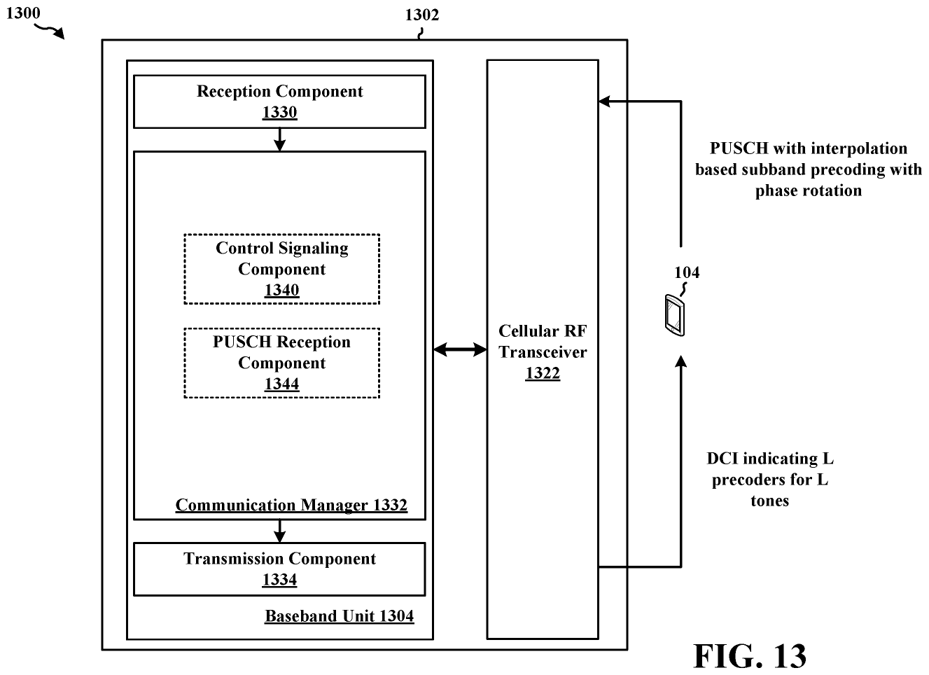

At 1206, the base station transmits DCI scheduling a PUSCH spanning multiple sub-bands, the DCI indicating a first precoder for a first resource grid of the PUSCH and a second precoder for a second resource grid of the PUSCH. The DCI may indicate a set of precoders for a set of resource grids of the PUSCH each resource grid of the set of resource grids being associated with a frequency sector. The phase rotation may be based on a multiplication of the second precoder by an orthonormal matrix. In some aspects, the orthonormal matrix may be an identity matrix. The transmission may be performed, e.g., by the control signaling component 1340 of the apparatus 1302 in FIG. 13. FIG. 9 illustrates an example of a base station 904 transmitting a DCI 910 to the UE 902. Each resource grid may correspond to a tone, a set of tones, an RE, a set of REs, an RB, or a set of RBs, for example.

At 1208, the base station receives the PUSCH with the first precoder at the first resource grid and with a third precoder at the second resource grid, the third precoder being based on a phase rotation of the second precoder. The reception may be performed, e.g., by the PUSCH reception component 1344 of the apparatus 1302 in FIG. 13. FIG. 9 illustrates an example of the base station 904 receiving a PUSCH 916. The PUSCH may include any of the aspects described in connection with FIG. 7.

FIG. 12B illustrates a flowchart 1250 of a method of wireless communication that may include the transmission of the DCI as in 1206 and the reception of the PUSCH, as in 1210 of FIG. 12A. As illustrated at 1210, the base station may receive the PUSCH at resource grids between the first resource grid and the second resource grid with an interpolated precoder based on the first precoder and the third precoder. The interpolated precoder may be based on linear interpolation. The reception may be performed, e.g., by the PUSCH reception component 1344 of the apparatus 1302 in FIG. 13. Each resource grid of the PUSCH may be precoded with a precoder that is orthogonalized and normalized based on the interpolated precoder. Each precoder of the PUSCH transmission may be phase rotated at a sector boundary. Each resource grid of a sector received by the base station may be precoded with a phase rotated precoder. The frequency sector may span a set of one or more RBs. The frequency sector may span a number of one or more REs. FIG. 7 illustrates example aspects of applying phase rotation at a set of L frequency resources for a PUSCH. Aspects of linear interpolation are described in connection with FIGS. 6 and 7.

As illustrated at 1202, the base station may transmit an indication to the UE enabling sub-band precoding with the phase rotation. FIG. 9 illustrates an example of an indication 906 from the base station. The enablement/disablement may enable more variation or adaptation to the current conditions of a channel. In some aspects, at 1204, the base station may transmit an indication to the UE of a set of at least one phase rotation matrix, the phase rotation being based, at least in part, on the indication. The reception of the indications may be performed, e.g., by the control signaling component 1340 of the apparatus 1302. FIG. 9 illustrates an example of a base station 904 transmitting an indication 907 to the UE 902.

FIG. 13 is a diagram 1300 illustrating an example of a hardware implementation for an apparatus 1302. The apparatus 1302 may be a base station, a component of a base station, or may implement base station functionality. In some aspects, the apparatus 1102 may include a baseband unit 1304. The baseband unit 1304 may communicate through a cellular RF transceiver 1322 with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the base station 310 and may include the memory 376 and/or at least one of the TX processor 316, the RX processor 370, and the controller/processor 375.

The communication manager 1332 includes a control signaling component 1340 that is configured to transmit DCI scheduling a PUSCH spanning multiple sub-bands, the DCI indicating a first precoder for a first resource grid of the PUSCH and a second precoder for a second resource grid of the PUSCH, e.g., as described in connection with 1206 in FIG. 12A or 12B. The control signaling component 1340 may be further configured to indicate to a UE that phase rotation is enabled, e.g., as described in connection with 1202 and/or a set of one or more phase rotation matrices, e.g., as described in connection with 1204 in FIG. 12B. The communication manager 1332 further includes a PUSCH reception component 1344 that is configured to receive the PUSCH with the first precoder at the first resource grid and with a third precoder at the second resource grid, the third precoder being based on a phase rotation of the second precoder, e.g., as described in connection with 1208 in FIG. 12A or 12B. The PUSCH reception component 1344 may be further configured to receive the PUSCH at resource grids between the first resource grid and the second resource grid with an interpolated precoder based on the first precoder and the third precoder, e.g., as described in connection with 1210 in FIG. 12B.

The apparatus may include additional components that perform each of the blocks of the algorithm in the flowcharts of FIGS. 12A and 12B and/or the aspects performed by the base station in the communication flow in FIG. 9. As such, each block in the flowcharts of FIGS. FIGS. 12A and 12B and/or the aspects performed by the base station in the communication flow in FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the baseband unit 1304, includes means for transmitting downlink control information scheduling a PUSCH spanning multiple sub-bands, the DCI indicating a first precoder for a first resource grid of the PUSCH and a second precoder for a second resource grid of the PUSCH; and means for receiving the PUSCH with the first precoder at the first resource grid and with a third precoder at the second resource grid, the third precoder being based on a phase rotation of the second precoder. The apparatus 1302 may further include means for receiving the PUSCH at resource grids between the first resource grid and the second resource grid with an interpolated precoder based on the first precoder and the third precoder. The apparatus 1302 may further include means for transmitting an indication to the UE enabling sub-band precoding with the phase rotation. The apparatus 1302 may further include means for transmitting an indication to the UE of a set of at least one phase rotation matrix, the phase rotation being based, at least in part, on the indication. The means may be one or more of the components of the apparatus 1302 configured to perform the functions recited by the means. As described supra, the apparatus 1302 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a UE, comprising: receiving DCI scheduling a PUSCH spanning multiple sub-bands, the DCI indicating a first precoder for a first resource grid of the PUSCH and a second precoder for a second resource grid of the PUSCH; and transmitting the PUSCH with the first precoder at the first resource grid and with a third precoder at the second resource grid, the third precoder being based on a phase rotation of the second precoder.

In aspect 2, the method of aspect 1 further includes that each resource grid corresponds to one of a RE, a set of REs, a RB, or a set of RBs.

In aspect 3, the method of aspect 1 or aspect 2 further includes that the phase rotation includes multiplication of the second precoder by an orthonormal matrix.

In aspect 4, the method of aspect 3 further includes that the orthonormal matrix is an identity matrix.

In aspect 5, the method of any of aspects 1-4 further includes transmitting the PUSCH at resource grids between the first resource grid and the second resource grid with an interpolated precoder based on the first precoder and the third precoder.

In aspect 6, the method of aspect 5 further includes that the interpolated precoder is based on linear interpolation.

In aspect 7, the method of aspect 5 or aspect 6 further includes that each resource grid of the PUSCH is precoded with an precoder that is orthogonalized and normalized based on the interpolated precoder.

In aspect 8, the method of any of aspects 1-7 further includes that the DCI indicates a set of precoders for a set of resource grids of the PUSCH, each resource grid of the set of resource grids being associated with a frequency sector.

In aspect 9, the method of aspect 8 further includes phase rotating each precoder at a sector boundary.

In aspect 10, the method of aspect 8 or aspect 9 further includes interpolating between two precoders to obtain a corresponding precoder for resource grids between two closest resource grids of the set of resource grids for which the set of precoders are indicated.

In aspect 11, the method of any of aspects 8-10 further includes that the frequency sector spans a set of one or more RBs.

In aspect 12, the method of any of aspects 8-10 further includes that the frequency sector spans a number of REs.

Aspect 13 is an apparatus for wireless communication comprising means to perform the method of any of aspects 1-12.

In aspect 14, the apparatus of aspect 13 further includes at least one antenna coupled to the means to perform the method of any of aspects 1-12.

In aspect 15, the apparatus of aspect 13 or 14 further includes a transceiver coupled to the means to perform the method of any of aspects 1-12.

Aspect 16 is an apparatus for wireless communication comprising memory and at least one processor coupled to the memory and configured to, based at least in part on information stored in the memory, perform the method of any of aspects 1-12.

In aspect 17, the apparatus of aspect 16 further includes at least one antenna coupled to the at least one processor.

In aspect 18, the apparatus of aspect 16 or 17 further includes a transceiver coupled to the at least one processor.

Aspect 19 is a non-transitory computer-readable storage medium storing computer executable code, the code when executed by a processor causes the processor to perform the method of any of aspects 1-12.

Aspect 20 is a method of wireless communication at a base station, comprising transmitting DCI scheduling a PUSCH spanning multiple sub-bands, the DCI indicating a first precoder for a first resource grid of the PUSCH and a second precoder for a second resource grid of the PUSCH; and receiving the PUSCH with the first precoder at the first resource grid and with a third precoder at the second resource grid, the third precoder being based on a phase rotation of the second precoder.

In aspect 21, the method of aspect 20 further includes that each resource grid corresponds to one of a RE, a set of REs, a RB, or a set of RBs.

In aspect 22, the method of aspect 20 or 21 further includes that the phase rotation is based on a multiplication of the second precoder by an orthonormal matrix.

In aspect 23, the method of aspect 22 further includes that the orthonormal matrix is an identity matrix.

In aspect 24, the method of any of aspects 20-23 further includes receiving the PUSCH at resource grids between the first resource grid and the second resource grid with an interpolated precoder based on the first precoder and the third precoder.

In aspect 25, the method of aspect 24 further includes that the interpolated precoder is based on linear interpolation.

In aspect 26, the method of aspect 24 or 25 further includes that each resource grid of the PUSCH is precoded with a precoder that is orthogonalized and normalized based on the interpolated precoder.

In aspect 27, the method of any of aspects 20-26 further includes that the DCI indicates a set of precoders for a set of resource grids of the PUSCH each resource grid of the set of resource grids being associated with a frequency sector.

In aspect 28, the method of aspect 27 further includes that each precoder is phase rotated at a sector boundary.

In aspect 29, the method of aspect 27 or 28 further includes that each resource grid of a sector is precoded with a phase rotated precoder.

In aspect 30, the method of any of aspects 27-29 further includes that the frequency sector spans a set of one or more RBs.

In aspect 31, the method of any of aspects 27-29 further includes that the frequency sector spans a number of REs.

Aspect 32 is an apparatus for wireless communication comprising means to perform the method of any of aspects 20-31.

In aspect 33, the apparatus of aspect 32 further includes at least one antenna coupled to the means to perform the method of any of aspects 20-31.

In aspect 34, the apparatus of aspect 32 or 33 further includes a transceiver coupled to the means to perform the method of any of aspects 20-31.

Aspect 35 is an apparatus for wireless communication comprising memory and at least one processor coupled to the memory and configured to, based at least in part on information stored in the memory, perform the method of any of aspects 20-31.

In aspect 36, the apparatus of aspect 35 further includes at least one antenna coupled to the at least one processor.

In aspect 37, the apparatus of aspect 35 or 36 further includes a transceiver coupled to the at least one processor.

Aspect 38 is a non-transitory computer-readable storage medium storing computer executable code, the code when executed by a processor causes the processor to perform the method of any of aspects 20-31.

What is claimed is:

1. An apparatus for wireless communication at a user equipment (UE), comprising:
memory; and
at least one processor coupled to the memory and configured to, based at least in part on information stored in the memory:
receive downlink control information (DCI) scheduling a physical uplink shared channel (PUSCH) spanning multiple sub-bands, the DCI indicating a first precoder for a first resource grid of the PUSCH and a second precoder for a second resource grid of the PUSCH; and
transmit the PUSCH with the first precoder at the first resource grid and with a third precoder at the second resource grid, the third precoder being based on a phase rotation of the second precoder.

2. The apparatus of claim 1, wherein each resource grid corresponds to one of a resource element (RE), a set of REs, a resource block (RB), or a set of RBs.

3. The apparatus of claim 1, wherein the phase rotation includes multiplication of the second precoder by an orthonormal matrix.

4. The apparatus of claim 3, wherein the orthonormal matrix is an identity matrix.

5. The apparatus of claim 1, wherein the at least one processor is further configured to, based at least in part on the information stored in the memory:
transmit the PUSCH at resource grids between the first resource grid and the second resource grid with an interpolated precoder based on the first precoder and the third precoder.

6. The apparatus of claim 5, wherein the interpolated precoder is based on linear interpolation.

7. The apparatus of claim 5, wherein each resource grid of the PUSCH is precoded with an precoder that is orthogonalized and normalized based on the interpolated precoder.

8. The apparatus of claim 1, wherein the DCI indicates a set of precoders for a set of resource grids of the PUSCH, each resource grid of the set of resource grids being associated with a frequency sector.

9. The apparatus of claim 8, wherein the at least one processor is further configured to, based at least in part on the information stored in the memory:
phase rotate each precoder at a sector boundary.

10. The apparatus of claim 8, wherein the at least one processor is further configured to, based at least in part on the information stored in the memory:
interpolate between two precoders to obtain a corresponding precoder for resource grids between two closest resource grids of the set of resource grids for which the set of precoders are indicated.

11. The apparatus of claim 8, wherein the frequency sector spans a set of one or more resource blocks (RBs).

12. The apparatus of claim 8, wherein the frequency sector spans a number of resource elements.

13. The apparatus of claim 1, further comprising:
at least one of antenna coupled to the at least one processor.

14. A method of wireless communication at a user equipment (UE), comprising:
receiving downlink control information (DCI) scheduling a physical uplink shared channel (PUSCH) spanning multiple sub-bands, the DCI indicating a first precoder for a first resource grid of the PUSCH and a second precoder for a second resource grid of the PUSCH; and
transmitting the PUSCH with the first precoder at the first resource grid and with a third precoder at the second resource grid, the third precoder being based on a phase rotation of the second precoder.

15. The method of claim 14, further comprising:
transmitting the PUSCH at resource grids between the first resource grid and the second resource grid with an interpolated precoder based on the first precoder and the third precoder.

16. An apparatus for wireless communication at a base station, comprising:
memory; and
at least one processor coupled to the memory and configured to, based at least in part on information stored in the memory:
transmit downlink control information (DCI) scheduling a physical uplink shared channel (PUSCH) spanning multiple sub-bands, the DCI indicating a first precoder for a first resource grid of the PUSCH and a second precoder for a second resource grid of the PUSCH; and
receive the PUSCH with the first precoder at the first resource grid and with a third precoder at the second resource grid, the third precoder being based on a phase rotation of the second precoder.

17. The apparatus of claim 16, wherein each resource grid corresponds to one of a resource element (RE), a set of REs, a resource block (RB), or a set of RBs.

18. The apparatus of claim 16, wherein the phase rotation is based on a multiplication of the second precoder by an orthonormal matrix.

19. The apparatus of claim 18, wherein the orthonormal matrix is an identity matrix.

20. The apparatus of claim 16, wherein the at least one processor is further configured to, based at least in part on the information stored in the memory:
receive the PUSCH at resource grids between the first resource grid and the second resource grid with an interpolated precoder based on the first precoder and the third precoder.

21. The apparatus of claim 20, wherein the interpolated precoder is based on linear interpolation.

22. The apparatus of claim 20, wherein each resource grid of the PUSCH is precoded with a precoder that is orthogonalized and normalized based on the interpolated precoder.

23. The apparatus of claim 16, wherein the DCI indicates a set of precoders for a set of resource grids of the PUSCH each resource grid of the set of resource grids being associated with a frequency sector.

24. The apparatus of claim 23, wherein each precoder is phase rotated at a sector boundary.

25. The apparatus of claim 24, wherein each resource grid of a sector is precoded with a phase rotated precoder.

26. The apparatus of claim 23, wherein the frequency sector spans a set of one or more resource blocks (RBs).

27. The apparatus of claim 23, wherein the frequency sector spans a number of resource elements.

28. The apparatus of claim 16, further comprising:
at least one of antenna coupled to the at least one processor.

29. A method of wireless communication at a base station, comprising:
transmitting downlink control information (DCI) scheduling a physical uplink shared channel (PUSCH) spanning multiple sub-bands, the DCI indicating a first precoder for a first resource grid of the PUSCH and a second precoder for a second resource grid of the PUSCH; and
receiving the PUSCH with the first precoder at the first resource grid and with a third precoder at the second resource grid, the third precoder being based on a phase rotation of the second precoder.

30. The method of claim 29, further comprising:
receiving the PUSCH at resource grids between the first resource grid and the second resource grid with an interpolated precoder based on the first precoder and the third precoder.
